(19) United States
(12) Patent Application Publication
(10) Pub. No.: US 2017/0147955 A1
(43) Pub. Date: May 25, 2017

(54) ENTERPRISE RESOURCE MANAGEMENT TOOLS

(71) Applicant: INTERNATIONAL BUSINESS MACHINES CORPORATION, ARMONK, NY (US)

(72) Inventors: Raphael Ezry, New York, NY (US); Munish Goyal, Armonk, NY (US); Thomas A. Stachura, Wheaton, IL (US); Amy Wright, Cinnaminson, NJ (US)

(21) Appl. No.: 14/951,843

(22) Filed: Nov. 25, 2015

(51) Int. Cl. G06Q 10/06; G06F 17/30

(52) U.S. Cl. CPC G06Q 10/06313; G06F 17/30241

(57) ABSTRACT

Computing systems, methods and tools for managing and optimizing the allocation of enterprise resources by automating employee management decision making to align management decisions made on a local level with the goals of the overall enterprise, global economies and emerging market trends. The computing systems, methods and tools use historical data, objective attributes and subjective feedback at the local level to predict employee progression at specific points in time of an employee's career and the effects particular management decisions may have on the employee as an asset of an enterprise, in order to predict, calculate and select the optimal actions that will further improve the employee's value to the enterprise yielding an optimal return on the investment of resources.

### TECHNICAL FIELD

The present disclosure relates generally to computerized management tools and methods for optimally distributing enterprise resources among geographically distributed employees.

### BACKGROUND

Enterprise leaders consistently identify “attracting, retaining, and developing talent” as a priority, as well as a top business challenge for the future. Enterprises recognize that success often depends on having the right people, in the right place, at the right time, and for the right cost. The ability to anticipate and rapidly respond to changing workforce needs, and to optimally allocate resources to members of an enterprise to meet those needs, takes on increased importance in the dynamic global economy of today.

Employee managers hold a unique responsibility of engaging current and prospective employees to help develop these individuals into valuable assets with an ideal set of experiences and capabilities, while only expending a limited amount of available resources. In large, geographically distributed organizations, managers often face the uphill tasks of collecting data about employees in order to make strategic recommendations relating to the distribution of resources that align with the business's global strategy. While retaining and promoting talented employees is a top priority, many organizations find it challenging to strategically allocate resources to their workforce in a manner calculated to achieve optimal returns on the enterprise's investment. The pace of change within economies, industries, and organizations continue to accelerate, while labor markets continue to become more competitive, more global. As the workforce continues to become more diverse in terms of its demographics, expectations, and goals, the allocation of enterprise resources becomes more difficult to manage and to anticipate the optimal return on a resource's investment.

### SUMMARY

A first embodiment of the present disclosure provides a method for optimizing an allocation of enterprise resources, said method comprising the steps of: receiving, by the computer processor, a set of employee data from one or more data sources; identifying, by the computer processor, as a function of the set of employee data, a state of an employee; generating, by the computer processor, a probability of the employee transitioning from the state of the employee to a different state as a function of a selected employee action having a reward value; calculating, by the computer processor, as a function of the probability, an optimal employee action wherein the optimal employee action yields an optimal reward; computing, by the computer processor, an index value and cost pair for the selected action, wherein the index value is reduced until the index value multiplied by the reward value renders the selected employee action as the optimal employee action; transmitting, by the computer processor, the index value and the cost pair to a central node; receiving, by the computer processor, an index threshold value from the central node, wherein the index threshold value is calculated as a function of the index value and cost pair transmitted to the central node; and comparing, by the computer processor, the index value of the selected employee action with the index threshold value.

A second embodiment of the present disclosure provides a computer program product, comprising one or more computer readable hardware storage devices having computer readable program code stored therein, said program code containing instructions executable by the one or more computer processors to implement a method for optimizing an allocation of enterprise resources, said method comprising the steps of: receiving, by the computer processor, a set of employee data from one or more data sources; identifying, by the computer processor, as a function of the set of employee data, a state of an employee; generating, by the computer processor, a probability of the employee transitioning from the state of the employee to a different state as a function of a selected employee action having a reward value; calculating, by the computer processor, as a function of the probability, an optimal employee action wherein the optimal employee action yields an optimal reward; computing, by the computer processor, an index value and cost pair for the selected action, wherein the index value is reduced until the index value multiplied by the reward value renders the selected employee action as the optimal employee action; transmitting, by the computer processor, the index value and the cost pair to a central node; receiving, by the computer processor, an index threshold value from the central node, wherein the index threshold value is calculated as a function of the index value and cost pair transmitted to the central node; and comparing, by the computer processor, the index value of the selected employee action with the index threshold value

A third embodiment of the present disclosure provides a computer system, comprising one or more processors, one or more memories coupled to the one or more computer processors, and one or more computer readable storage devices coupled to the one or more processors, said one or more storage devices containing program code executable by the one or more processors via one or more memories to implement a method for optimizing an allocation of enterprise resources, said method comprising the steps of: receiving, by the computer processor, a set of employee data from one or more data sources; identifying, by the computer processor, as a function of the set of employee data, a state of an employee; generating, by the computer processor, a probability of the employee transitioning from the state of the employee to a different state as a function of a selected employee action having a reward value; calculating, by the computer processor, as a function of the probability, an optimal employee action wherein the optimal employee action yields an optimal reward; computing, by the computer processor, an index value and cost pair for the selected action, wherein the index value is reduced until the index value multiplied by the reward value renders the selected employee action as the optimal employee action; transmitting, by the computer processor, the index value and the cost pair to a central node; receiving, by the computer processor, an index threshold value from the central node, wherein the index threshold value is calculated as a function of the index value and cost pair transmitted to the central node; and comparing, by the computer processor, the index value of the selected employee action with the index threshold value.

### BRIEF DESCRIPTION OF THE DRAWINGS

FIG. 1 depicts an embodiment of a computing network for implementing embodiments of the present invention.

FIG. 2 depicts a cloud computing network for implementing embodiments of the present invention.

FIG. 3 depicts abstraction model layers of a cloud computing network implementing embodiments of the present invention.

FIG. 4 illustrates a high level flowchart describing embodiments of an algorithm of the present invention.

FIG. 5 depicts a flowchart illustrating an embodiment of the steps for performing state space segmentation and temporal analysis of an employee.

FIG. 6 depicts a flowchart illustrating an embodiment of the steps for calculating a maximum reward for implementing an optimal employee action.

FIG. 7 depicts a flowchart illustrating an embodiment of the steps for computing employee index values.

FIG. 8a depicts an embodiment of an employee valuation index, for a 1^{st} action.

FIG. 8b depicts an embodiment of an employee valuation index for a 2^{nd} action.

FIG. 8c depicts an embodiment of an employee valuation index for a 3^{rd} action.

FIG. 9 depicts a flowchart illustrating an embodiment of the steps for calculating an index threshold.

FIG. 10 depicts an embodiment of an index value table for a plurality of employee ids.

FIG. 11 illustrates an embodiment of a computer system used for implementing tools, methods and systems consistent with embodiments of the present invention.

### DETAILED DESCRIPTION

Embodiments of the present invention enable computing systems, methods and tools for managing and optimizing the allocation of resources available to large scale and geographically dispersed enterprises. Embodiments of the present disclosure may be implemented for managing resource allocation, including but not limited to management of monetary compensation, training and allocation of a limited number of promotions. The resource management tools of the present disclosure may automate employee management decisions of resource allocation, in an effort to align management decision making on a local level with the goals of the geographically dispersed enterprise, in order to receive optimal returns on the enterprise's investment of resources. The embodiments of the computing systems, tools and methods, utilize both subjective and objective input data at a local level, provided by local employee managers, to improve and automate decision making policies for the distribution of resources, while allowing for the enterprise to have the ability to adjust resource distribution in response to dynamic changes in worldwide economies, and the enterprise's overall business strategy.

Embodiments of the present invention may evaluate each employee, on an employee by employee basis to determine the relative life time value of each employee to the enterprise. The relative life time value may be measured in the form of an index value. Embodiments of the present invention evaluate the employee's current state and predict the employee life time effects of investing resources in the employee. In particular, embodiments of the invention may evaluate the effects of investing resource in an employee, measure the positive or negative transitions in the employee's state and determine whether allocating limited resources to a particular employee would be the most beneficial use of the enterprise's resources.

The measurement of the effects on a particular employee's state and the transition to a different state that may result from resource allocation, may be predicted using historical data from past and present employees having a state similar to the state of the particular employee being evaluated. From the historical employee data, and the use of predictive modeling, embodiments of the current invention may identify the employees that will predictively benefit the enterprise the most from the investment of limited resources and indicate to the employee managers of the enterprise, the optimal actions the employee manager should employ for each employee (if any actions at all) to meet the dynamic goals of the enterprise in an optimized manner.

The relative value of each employee to the enterprise may be calculated at the local level and presented in the form of an index value. The index value for each employee may indicate the overall benefits the enterprise may receive from a particular employee by implementing a particular action that may cost resources (such as promotion, increased compensation, upskilling or cross-skilling). Each employee's index value and an associated cost pair may be transmitted to a central node for computation on an enterprise wide level.

The index value and cost pair may reduce the number of calculations and predictions that may need to be performed by the central node. Instead of having to make predictions for each and every employee at a centralized location, which may include hundreds of thousands of employees, the computing systems, management tools and methods, improve hardware and software capabilities of the enterprise by enabling the enterprise to optimize the allocation of resources to employees predicted to provide the best return on the resource investment. The optimization of the resource allocation may occur by setting an index threshold that will limit the number of employee actions taken by local managers, to those employee actions that will return the highest amount of benefits to the enterprise at the global level.

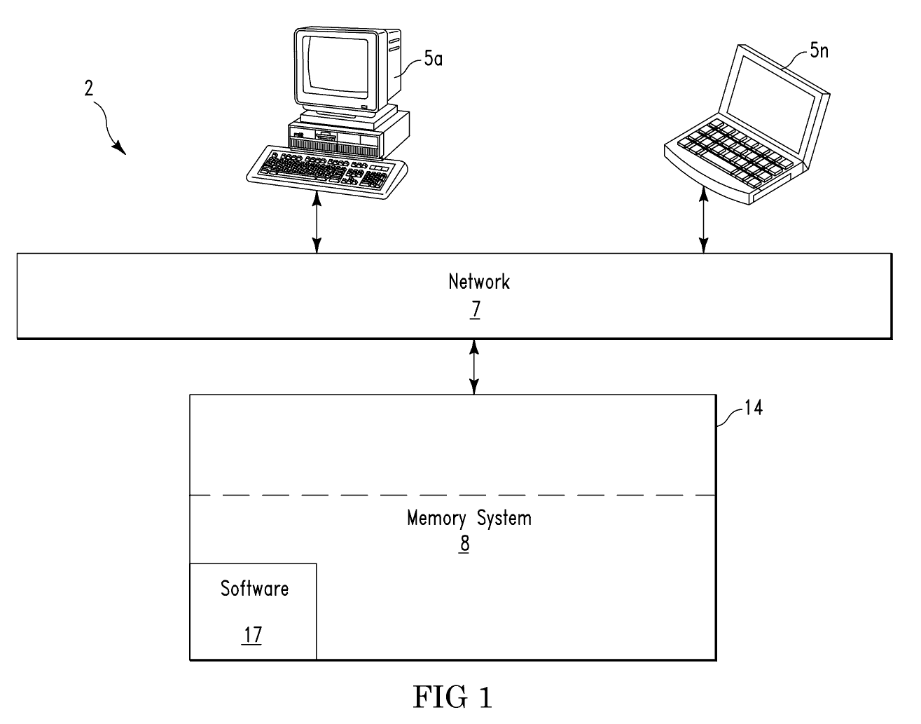

Referring to the drawings, FIG. 1 depicts an embodiment of a computing network for optimizing the allocation of enterprise resources. The embodiment of the resource management system may include one or more nodes 5a . . . 5n connected through a network 7 to a computing system 14. There are not any limitations of the number of nodes that may be connected to the network 7, rather nodes 5a, 5b, 5c . . . 5n are meant to demonstrate that a plurality of one or more nodes may be connected to the network 7. Network 7 may include any type of network including, inter alia, a local area network, (LAN), a wide area network (WAN), the Internet, a wireless network, etc. Nodes 5a . . . 5n may include any type of computing system(s) including, inter alia, a computer (PC), a laptop computer, a tablet computer, a server, a PDA, a smart phone, etc. Computing system 14 may include any type of computing system(s) including, inter alia, a computer (PC), a laptop computer, a tablet computer, a server, etc. Computing system 14 includes a memory system 8. Memory system 8 may include a single memory system. Alternatively, memory system 8 may include a plurality of memory systems. Memory system 8 includes software 17 comprising computer programming code for resource management tools implementing methods for optimizing the allocation of enterprise resources in the resource management system.

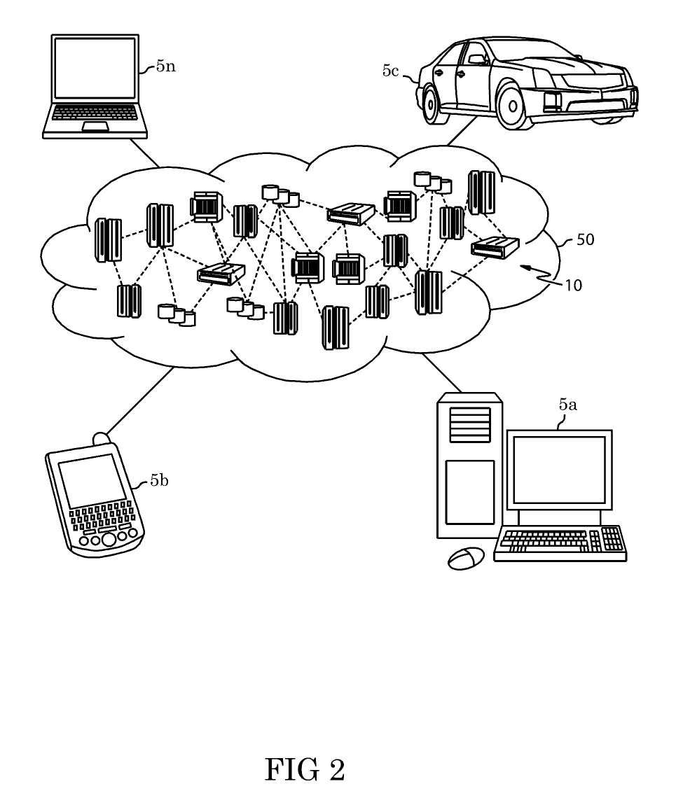

In some embodiments, the computer network 7 may be a cloud computing network operating under a cloud computing environment 50 (as shown in FIG. 2). Cloud computing may be referred to as a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Embodiments of a cloud computing model may include one or more of at least five characteristics, at least three service models, and at least four deployment models.

Characteristics of a cloud computing environment may include on-demand self-service, broad network access, resource pooling, rapid elasticity and measured service. The term “on-demand self-service” may refer to a characteristic of a cloud computing environment that may allow a tenant of the cloud environment to unilaterally provision computing capabilities, such as server time and network storage, as needed, automatically without requiring human interaction with the owner of the cloud environment.

“Broad network access” may refer to the capabilities available over the network which may be accessed through standard mechanisms that promote use by heterogeneous thin or thick client platforms (e.g., mobile phones, laptops, and PDAs).

“Resource pooling” may refer to the tenant's computing resources being pooled to serve multiple tenants using a multi-tenant model, with different physical and virtual resources dynamically assigned and reassigned according to demand. There is a sense of location independence in that the tenant may generally have no control or knowledge over the exact location of the provided resources but may be able to specify location at a higher level of abstraction (e.g., country, state, or datacenter).

“Rapid elasticity” refers to capabilities of the cloud network to rapidly and elastically provision, in some cases automatically, to quickly scale out and rapidly released to quickly scale in. To the tenant, the capabilities available for provisioning may appear to be unlimited and can be purchased in any quantity at any time.

“Measured service” may refer to cloud systems being able automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

The service models for a cloud computing environment may include Software as a Service (SaaS), Platform as a Service (PaaS) and Infrastructure as a Service (IaaS). Software as a Service (SaaS) refers to the capability provided to the tenant to use the service provider's applications running on a cloud infrastructure. The applications are accessible from various client devices through a thin client interface such as a web browser (e.g., web-based e-mail). The tenant does not manage or control the underlying cloud infrastructure including network, servers, operating systems, storage, or even individual application capabilities, with the possible exception of limited user-specific application configuration settings.

Platform as a Service (PaaS) refers to the capability provided to the consumer to deploy onto the cloud infrastructure tenant-created or acquired applications created using programming languages and tools supported by one or more service providers. The tenant does not manage or control the underlying cloud infrastructure including networks, servers, operating systems, or storage, but has control over the deployed applications and possibly application hosting environment configurations. In contrast, Infrastructure as a Service (IaaS) refers to the capability provided to the tenant to provision processing, storage, networks, and other fundamental computing resources where the consumer is able to deploy and run arbitrary software, which can include operating systems and applications. The tenant does not manage or control the underlying cloud infrastructure but has control over operating systems, storage, deployed applications, and possibly limited control of select networking components (e.g., host firewalls).

Deployment models of a cloud computing environment such as the one depicted in FIG. 2 may include a private cloud, community cloud, public cloud or hybrid cloud. A “private cloud” refers to cloud infrastructure that is operated solely for an organization. It may be managed by the organization or a third party and may exist on-premises or off-premises. A “community cloud” may refer to cloud infrastructure is shared by several organizations and supports a specific community that has shared concerns (e.g., mission, security requirements, policy, and compliance considerations). It may be managed by the organizations or a third party and may exist on-premises or off-premises.

A “public cloud” deployment model may refer to cloud infrastructure that is made available to the general public or a large industry group and is owned by an organization selling cloud services to one or more tenants. A “hybrid cloud” may refer to cloud infrastructure that is a composition of two or more clouds (private, community, or public) that remain unique entities but are bound together by standardized or proprietary technology that enables data and application portability (e.g., cloud bursting for load-balancing between clouds).

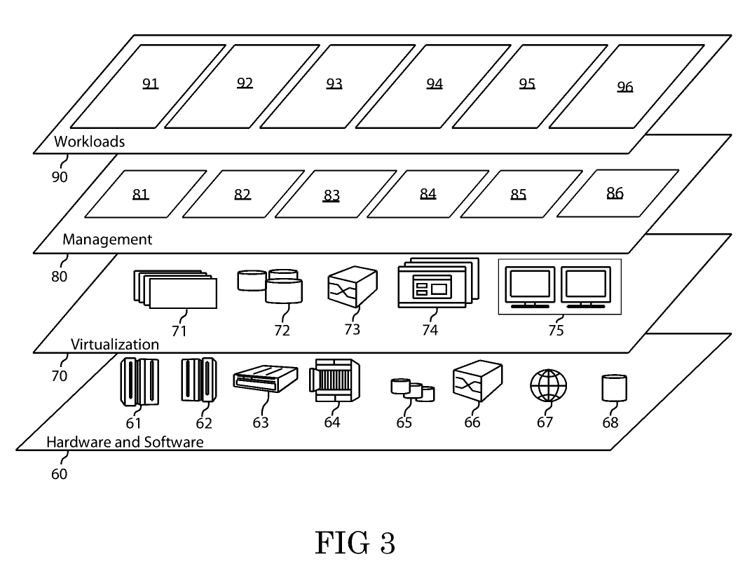

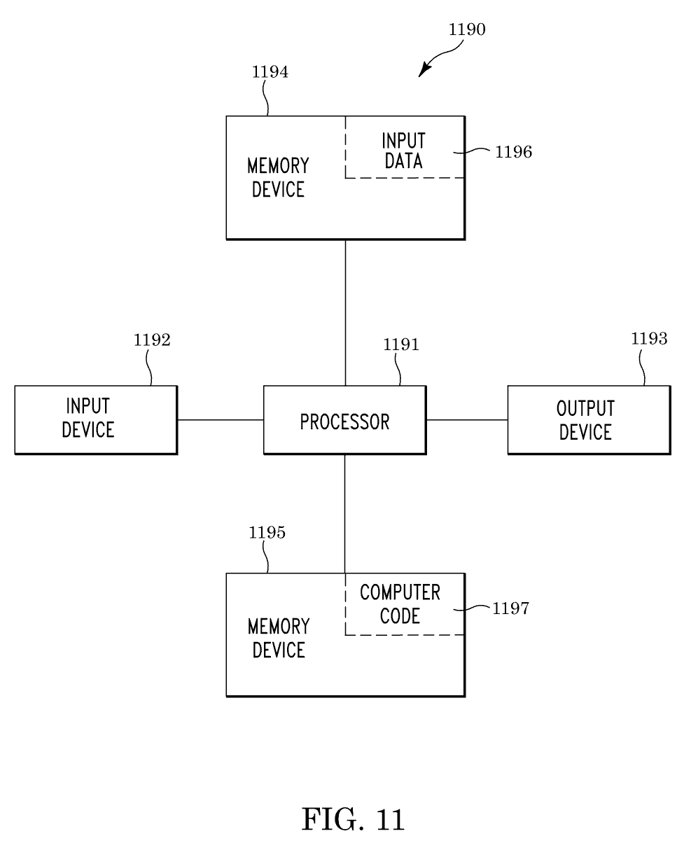

A cloud computing environment may be considered service oriented with a focus on statelessness, low coupling, modularity, and semantic interoperability. At the heart of cloud computing environment may be an infrastructure comprising a network of interconnected nodes. Referring now to FIG. 3, illustrating an embodiment of a cloud computing environment 50, the cloud computing environment 50 may comprise one or more cloud computing nodes 10 with which local computing devices used by cloud tenants and/or services providers connected to the cloud computing environment. The computing nodes 10 may include for example, desktop computer 5a, personal digital assistant (PDA) or cellular telephone 5b, automobile computer system 5c, and/or laptop computer 5n. Nodes 10 may communicate with one another. They may be grouped (not shown) physically or virtually, in one or more networks, such as Private, Community, Public, or Hybrid cloud environment as described hereinabove, or a combination thereof. This allows cloud computing environment 50 to offer infrastructure, platforms and/or software as services for which a cloud consumer does not need to maintain resources on a local computing device. It is understood that the types of computing devices 5a-n shown in FIGS. 2-3 are intended to be illustrative only and that computing nodes 10 and cloud computing environment 50 can communicate with any type of computerized device, such as the computer system depicted in FIG. 11 (described below), over any type of network and/or network addressable connection (e.g., using a web browser).

Referring now to FIG. 3, a set of functional abstraction layers provided by cloud computing environment 50 is shown. It should be understood in advance that the components, layers, and functions shown in FIG. 3 are intended to be illustrative only and embodiments of the disclosed invention are not limited thereto. As depicted, the following layers and corresponding functions are described further below.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

The management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA. Identity verification 86 verifies the permission granted to customers and/or service providers to access to network based resources and perform tasks in the cloud based environment 50.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the resource management tool 96.

In the present disclosure, the resource management tools of workload 96 may implement methods for allocating enterprise resources by automating employee management decisions and further improving the computing system's hardware capabilities by making management decisions in the cloud computing environment, having multiple computing nodes, rather than focusing the management decisions at a single, central node. Subsequently, aggregating simplified index/cost values identifying the relative values of each employee, to a centralized piece of hardware such as the mainframes 61, RISC (Reduced Instruction Set Computer) architecture based servers 62, servers 63, or blade servers 64, in order to perform an enterprise wide calculation that optimizes the distribution of resources at the local level by each of managers in charge of implementing employee actions, as described in detail below.

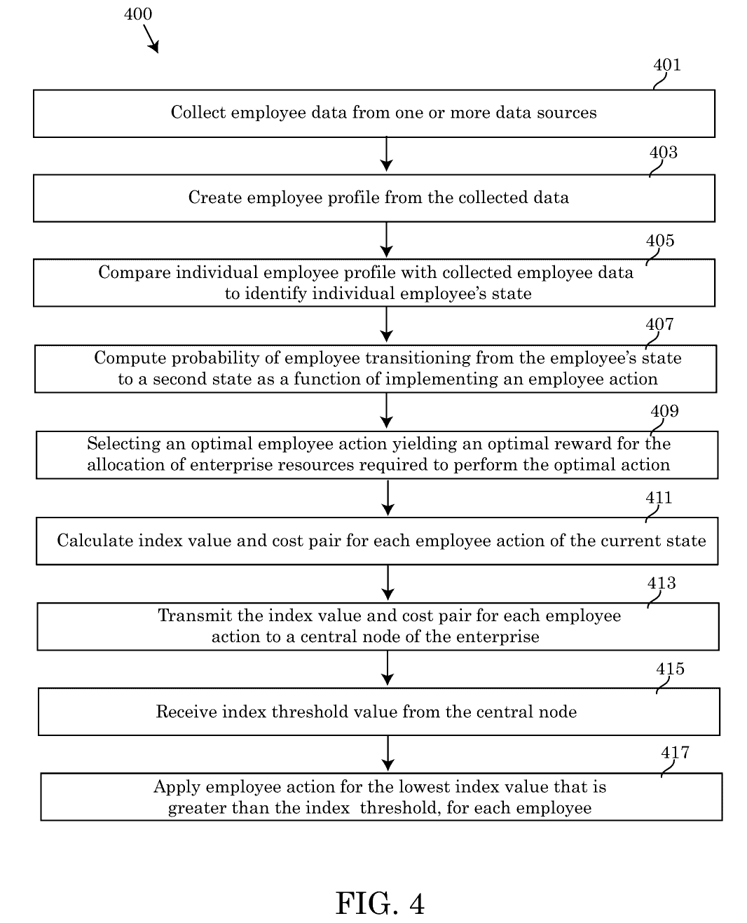

Referring to the drawings, FIG. 4 illustrates a high level flowchart of an embodiment 400 of an algorithm performing a method for optimizing an allocation of enterprise resource, using the resource management tools, which may be loaded into a resource management system. In step 401 of the method for optimizing the allocation of enterprise resources, the resource management tools may collect employee data from one or more data sources, for each employee of the enterprise. In step 403 resource management tools may further generate an employee profile from the collected employee data. Embodiments of the employee profile may describe the attributes, both subjective as well as objective, of the employee in the employee's current state at the enterprise.

The employee data collected from the data sources may be available to the resource management tools through locally accessible data sources or data sources available to the management tools as part of the computer network 7. Data sources may include data and metadata, from both publicly available and private structured files, unstructured files, databases, data sets, data sheets, spreadsheets, XML files, flat files, computer logs, network performance logs, search engine logs, social media, data marts, data warehouses, web sites and web services and any other data source known in the art, especially any data sources that provide historical data relating to employees of the enterprise, both past and present and one or more objective or subjective attributes of said employees.

The information available from the data sources may include information relating to the employees attributes, such as the employee's productivity, efficiency, education, expertise level, relative wage level, current compensation received, length of time retained by the enterprise and any other objectively calculated attribute of an employee. In addition to objective criteria, the resource management tools may further collect employee data that may subjectively describe the employee. Subjective employee data may include opinions relating to employees such as performance reviews, manager feedback, peer evaluations from fellow employees, and complaints or compliments received by the enterprise from fellow employees or customers.

In step 405, the resource management tools may identify the employee's current state by comparing the attributes of the employee's profile with employee profiles having substantially similar attributes. The “state” of an employee may refer to the collection attributes associated with an employee at a particular moment in time. Employees may be considered to have the same state, when the attributes of each employee are substantially similar overall. In some embodiments, the employee's state may be identified by applying a quantization/clustering algorithm model to employee's profile. The quantization/clustering algorithm may compare the attributes of the employee with the attributes of other past and present employees and then organize the employee profiles into groups based on the similarity of attributes.

Clustering/quantization algorithms may generally be directed toward models that organize data into a centroid based and hierarchal structure. Clustering/Quantization models may use inherent structures of the data (in this case, the employee attributes) to organize the data into groups that have the maximum amount of commonality within the groups and the maximum amount of differences between groups. In some embodiments the clustering/quantization models and algorithms may be integrated as a built in function of the resource management tools. In other embodiments, the clustering/quantization models may be part of an analytics engine, loaded into a resource management system as a separate module, integrated into the hardware or software of the computer network 7 or cloud computing network 50. In alternative embodiments, the clustering/quantization models and calculations may be performed by a separate dedicated computing system on the network of the enterprise.

As a result of the resource management tools identifying the current state of an employee, the resource management tools can make assumptions about an employee, based on the attributes associated with the particular state and the historical data of other employees who are currently or have previously been part of the same state.

Over the course of time, an employee's attributes may change enough for the employee to move from one state to another state. For example, a shift or change in attributes may occur as the managers of an enterprise invests resources in an employee by applying one or more particular employee actions to the employee during their time at the enterprise. As a result of the resource allocation in the employee, the employee may increase their skill level, wage index, education, or other employee attributes, causing their present state to transition to a different state. As an employee's state changes, the employee may be seen as more or less valuable to the enterprise.

To improve the predictive capabilities of the resource management tools, an employee state may not only be identified through comparisons between attributes of with present employees, but the comparison may also include historical data of enterprise employees who were previously part of the same employee state as the employee being evaluated by the resource management tools. The attributes and state information about employees from historical data may be particularly useful for determining how an employee, presently assigned to a current state, may transition from the current state to a another state. Along with the transition, the enterprise may determine the benefits that may be bestowed upon the enterprise as a result of this transition and the enterprise may determine whether investing resources to influence the transition to occur is worth the investment.

In step 407, the resource management tools may analyze the historical data to compute the probability that a particular allocation of resources by the enterprise will produce a transition from a current employee state to a different employee state, as a function of an employee action being taken by the managers of the enterprise. Each of the calculated probabilities may be tied to a specific employee action taken by the enterprise, which may have a different probability of transitioning the employee to a different state. Employee actions may include a change in compensation (increase or decrease), a promotion, up-skill training and/or cross-skill training. The phrase “up-skill training” may refer to teaching the current employee a new skill that may expand the employee's capabilities within the employee's current job functions. Cross-skill training on the other hand may refer to training an employee in a skill that is tangentially related to the current job functions of the employee.

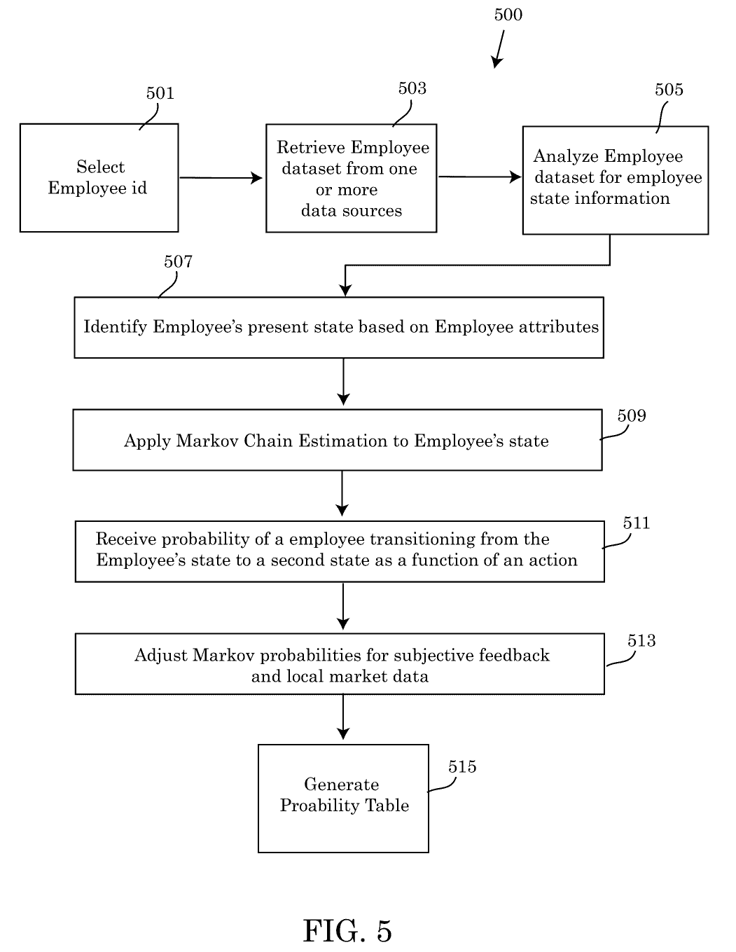

FIG. 5 describes an embodiment 500 of the steps the resource management tools implement to compute a probability of a specific employee transitioning from the employee's current state to a different state as a result of a particular employee action being taken. In step 501, the resource management tools select a specific employee id. The employee id may be the name of the employee, an employee number or an alphanumeric identifier that the resource management tools have associated with a particular employee. In some embodiments, the employee id may be retrieved by the resource management system from an employee data source that may collect employee ids using specialized biometric hardware that may scan employee fingerprints, iris, facial patterns, or other biometrics. The resource management tools may tie employee attributes and other employee data based on the biometric data.

In step 503, the resource management tools may retrieve, or download an employee dataset attached to the specific employee id selected in step 501, from the one or more data sources. In some embodiments, the employee dataset retrieved may be an employee profile, such as the profile described above having employee attributes described therein. The resource management tools may, in step 505 input the dataset for the particular employee into the analytics module and subsequently, the analytics module receiving the dataset input may compare the dataset and the employee attributes of the data set with other known employee datasets in order to identify similar employees of the same state having substantially similar employee attributes. In step 507, the resource management tools may receive an identification and confirmation of the state in which the employee s belongs to.

Once the state for the specific employee has been identified, in step 509, the resource management tools may calculate the probabilities of a transition occurring based on the implementation of hypothetical employee actions. The probabilities of a transition of an employee state occurring may be calculated by applying a Markov Chain estimation for the selected employee. A Markov Chain estimate may refer to a stochastic model that predicts the probability that a random process may undergo a transition from one state to another state. In Markov Chain estimation, the probability distribution may be dependent only on the current state of the employee and the sequence of events preceding the current state.

Using the employee attribute data and the historical information of the employee's current state, embodiments of the resource management tools in step 511, may perform, via the analytics engine, the Markov Chain Estimation. Embodiments of the resource management tools may subsequently receive from the analytics engine the resulting series of probabilities forecasting the likelihood that the selected employee of interest may transition from the present state, having a particular set of attributes, to a different state having a differing set of employee attributes, as a result of the resource management tools performing one or more employee actions.

In step 513, embodiments of the resource management tools that receive the probabilities from the analytics engine in step 511, may adjust the Markov probabilities on an employee by employee basis. For instance, in some embodiments, the resource management tools may adjust the probabilities based on subjective feedback. Subjective feedback that may be used to adjust the probabilities may include employee performance reviews, peer reviews or customer feedback. In alternative embodiments, the probabilities may be adjusted to account for local market data including supply trends, demand trends, wage trends, and the expectation that certain sectors of the economy may be profitable or disposable.

In step 515, the resource management tools may generate, update and/or store the probabilities calculated by the Markov Chain Estimation, as a probability table. The probability table may be saved to the employee data set, and may be recalled at a later point in time to predict the influence of future employee actions, and the state transitions that may result. Table 1 below is an example of a probability table that may be generated by the resource management tools, wherein the State transition models calculate the probability “P”, of an employee transitioning from a present state “s” as a function of the action “a” to a different state, such as state s′, s″, s′″, etc. It should be noted that Table 1 is a hypothetical set of probabilities and that the table may differ from employee to employee as well as with time due to evolving market conditions, even with employees that may classified as having the same current state.

TABLE 1

| | Probability of | Probability of | Probability of |
|---|---|---|---|
| | transitioning | transitioning | transitioning |
| Employee | states | states | states |
| Action | P(s′ \| s, aᵢ) | P(s″ \| s, aᵢ) | P(s′″ \| s, aᵢ) |
| a1 | 0.5 | 0.3 | 0.2 |
| a2 | 0.1 | 0.7 | 0.2 |
| a3 | 0.2 | 0.2 | 0.6 |

Referring to Table 1 above, the function P(s′|s,aᵢ) calculates the probability that the selected employee may transition from current state, s, to a second state, s′. As shown above, the probability of entering a different state from the present state may depend on the hypothetical action (aᵢ), requiring a proposed allocation of enterprise resources in order to be performed by the resource management tools. For instance, looking at Table 1 above, the probability that a particular employee may transition from the present state, s, to a different state, s′ when action a1 is performed is 0.5, or 50%. Action a1 for example may be the allocation of a promotion to the employee to a more senior position. Because only a limited number of promotions may be provided in any particular time period, the promotion may be considered a resource being allocated and consumed by the enterprise. However, if the promotion action, a1, is applied to the current employee example in Table 1, there is a 30% chance that the employee may transition to state, s″ and a 20% chance that the employee may transition to state, s′″. Each state may have a distinct set of employee attributes that may differ from the employees of the other states.

Depending on the attributes acquired by transitioning from the current state, “s”, to a second state, s′, s″ or s′″, the transition may be perceived by the enterprise as beneficial and may have a calculable amount of benefits to the enterprise as a return on the enterprise's investment of resources associated with performing a specific action (such as promoting) the selected employee. However, using the promotion of the exemplary employee as an example, there may only be a limited number of employee promotions that may be allocated by the pool of limited enterprise resources. The resource management tools not only predict the probabilities of transitioning the employee of Table 1, to a more beneficial state for the enterprise, but this calculation is repeated for each employee to identify the probabilities of other employees of the enterprise transitioning to a more beneficial state as well, in order to calculate which promotion action (or any employee action), from the limited number of available resources would benefit the enterprise the most.

Likewise, not only may the resource management tools calculate the probabilities that an employee may transition to a different state, via the employee action selected, but a separate set of state transition probabilities may be possible when a different employee action is selected. For instance, as noted above in Table 1, there was a 50% probability that an employee would enter transition from the current state, s to s′ state when action a1 was applied. However, if the enterprise implemented action a2, there would only be a 10% chance that the employee would transition from the present state, s to s′. Instead it would be more likely a probability that if the action a2 was applied, for example, increasing employee compensation by 5%, then there would be a 70% chance that the employee would transition from state, s to s″. The determination of whether to promote an employee using action a1 or to simply increase the compensation of the employee may depend on whether the enterprise considers s′ or s″ states to be more beneficial. For instance, if it is cheaper to increase compensation by 5% than to promote and s″ is a more beneficial state, the enterprise may determine that action a2 would be the more valuable action to implement for the particular employee of the examples above.

Based on the probabilities generated by the state transition models, using Markov Chain Estimation, embodiments of the resource management tools may predict the optimal actions for the particular employee, in order to identify the action that would yield the optimal allocation of resources. Namely, embodiments of the resource management tools determine the relative value of allocating resources to an employee through the implementation of an employee action, compared with the relative values of applying the resources to other employee actions, calculating the benefits received by performing the particular employee action and determining whether the resources may be more efficiently spent on other actions that may be less costly, or achieve greater benefits.

Embodiments of the resource management tools may utilize complex probability tables to chart the diverging paths and possibilities that an employee's career may follow from the present state, up to a specified point in time. The charting of a career path may be used by the resource management tools to estimate the long, mid and short term benefits of allocating resources in a particular manner to an employee. The resource management tools may be able to predict between 1 and 30 or more years into the future, depending on the amount of employee data that may be available. As the amount of employee data available to the resource management tools increases, the accuracy of predictions and the distance into the future that predictions may be made may also increase. The plotting of an employee's career path along multiple, alternative, diverging paths may assist the managers and the enterprise by visualizing the effects various employee actions may have on the employee's development, employee life time value, and the transitions of the employee from one state to another.

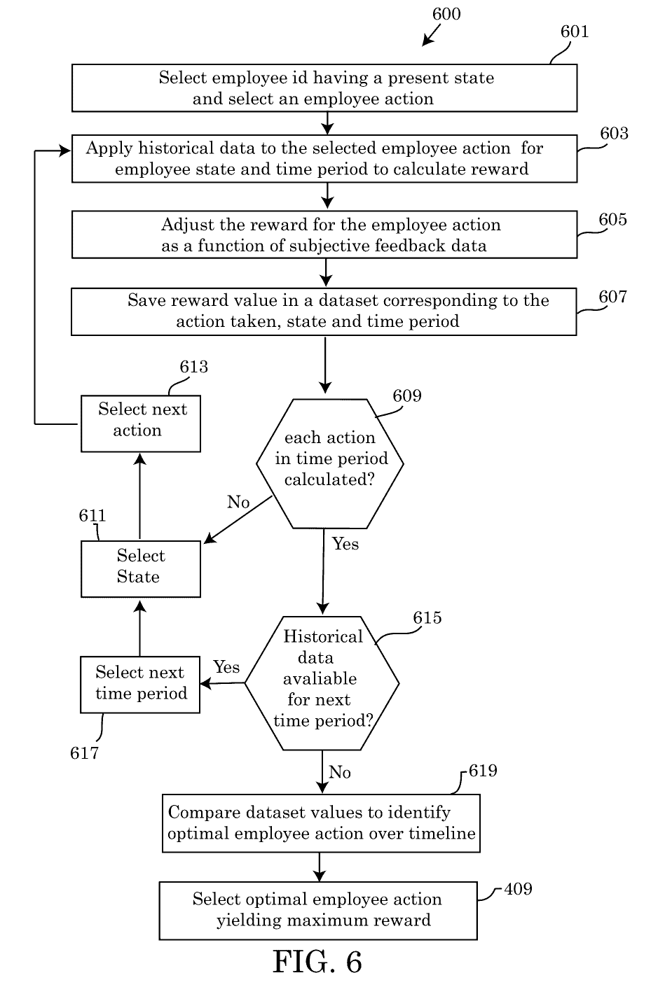

In step 409, embodiments of the resource management tools may calculate and select an optimal employee action and optimal reward, from the predicted career path of the employee using the generated probability tables and the calculable benefits associated with transitioning the employee from one state to another. FIG. 6 describes in embodiment 600, a method for selecting the optimal employee action in step 409. The method described in embodiment 600 teaches the specific steps that may be implemented by embodiments of the resource management tools to generate a predicted career path for an employee for a designated time frame, from the present, to another point in time in the future. Using the generated path, illustrating each possible pathway an investment of allocated resources may have on the employee, the resource management tools can select the optimal employee action that would yield the most beneficial outcome for the particular employee.

Embodiment of the method described in FIG. 6 may calculate each of the possible values an employee action may have and the employee action's influence the diverging pathways may have on an employee's career. The resource management tools may use the probabilities generated in the Markov chain estimation described above, and further calculate the benefits/rewards received by the enterprise itself for each employee action hypothetically implemented by the resource management tools and store the values resulting from each employee action in a dataset.

In step 601, embodiments of the resource management tools may select an initial employee id, the employee's present state and a first employee action that may be evaluated by the resource management tools. In step 603, the resource management tools may apply the historical data model to the selected employee action for the selected state at the current time period, and predicting a resulting employee life time reward value for the selected action. The resource management tools use the historical data for the particular employee state to predict, the life time reward that will be received as a result of performing the selected employee action. The historical information includes data of all the employees of the current state, that have or had similar attributes to the currently selected employee. The analytics engine of the resource management tools may use the historical data of the current state to predict the impact of each selected action on the selected employee by comparing the effects that the same action had on other employees of similar attributes within the same state and the benefits obtained by the enterprise.

Once the projected benefits to the enterprise has been calculated by the resource management tools in step 603, the benefit value may be adjusted using subjective employee data to compensate for individual anomalies that may make the selected employee more or less valuable based on the employees individual attributes and positive or negative reviews by the employee's peers or managers, which may positively or negatively impact the overall benefit calculation.

Examples of subjective employee data that may impact the adjustment of the enterprise benefit calculation in step 605, may include managerial feedback, performance reviews, peer reviews, etc. The predicted benefit for the selected employee action may, in step 607, be saved by the resource management tools in a dataset. The dataset with the reward value saved thereto, may further include additional identifying data regarding the selected employee, including, but not limited to the employee's id, the employee action taken, the state of the employee and/or attributes of the employee and a time period of the employee action.

Embodiments of the resource management tools may identify benefit values based on numerous possible pathways that may result from the manager's selection of an employee action. Embodiments of the resource management tools may account for every possible employee action that may occur within a time period, and within a particular state. Accounting for each possible outcome in an employee's career may be especially difficult when transitions to a different state are possible as a result of an employee action at a particular point in time. To account for such a large amount of variability, embodiments of the resource management tools may perform a determination at step 609. At step 609 embodiments of the resource management tools may determine whether or not the resource management tools have calculated each possible employee action and said employee action's benefit, within a particular time period.

If, at step 609, the resource management tools identifies that the reward value for every possible action at a particular time period has not been calculated, the resource management tools may proceed to step 611 and select the appropriate state. The appropriate state may be the same state as the first calculation described above for step 601, or a different state may be selected if, there is a probability that during the time period of interest, an employee action may have been applied to the selected employee that would have transitioned the employee to a different state.

After the appropriate state has been selected, in step 613 the next employee action may be selected for evaluation (e.g. promotion, increased compensation, upskilling, cross skilling etc.). The resource management tools may proceed back to step 603 and repeat the calculation steps 603, 605 and 607 for the selected state and employee action selected in step 611 and 613 respectively.

After each possible reward value has been calculated for each possible action, for each possible state an employee may be part of within a particular time period, the determination at step 609 may calculate that for the particular time period, each possible reward/action has been predicted. Accordingly, the resource management tools may subsequently determine in step 615, whether or there is historical data available for the next time period. As previously discussed above, the ability to predict an employee career path, may be limited to the amount of historical data available to the resource management tools, and the quality of the historical data. If, the resource management tools determine that there is sufficient data available to continue predicting the effects and rewards of employee actions applied to the selected employee in a time period that is further into the future, the resource management tools may proceed to step 617 and select the next available time period. Furthermore, the resource management tools may subsequently proceed to perform the actions of steps 611, 613, 603, 605, 607 and 609, until the resource management tools have predicted the effects of every employee action, for every probable state in the time period selected in period 617.

The resource management tools may continue to generate and save predicted outcomes and reward values for the selected employee until the resource management tools make the determination in step 615 that the resource management tools cannot predict the next subsequent time period based on the historical data available. Under such circumstances, where insufficient data is available to calculate an employee action result and reward for an employee action taken further into the future, the resource management tools may proceed to step 619.

In step 619, the resource management tools may compare dataset values for each of the reward values in step 607, wherein each of the data set values has a corresponding action taken, at a certain time period, within a state. Embodiments of the resource management tools may select the optimal employee action, yielding the maximum possible reward from the dataset in step 409.

Referring to the flow chart of FIG. 4, after calculating the optimal employee action yielding an optimal reward in step 409, embodiments of the resource management tools may proceed to step 411, wherein the resource management tools calculate an index value and cost pair for each employee action of the present state. The index value for a particular employee action may be designated by the symbol λ. The index value is a relative value compared to other employees of the enterprise. The index value describes the reward and benefit the enterprise may realize from implementing a particular action. The index value for each action that may require a resource investment, comparison is relative to the other employees of the enterprise. The index value designates how much value the enterprise may receive from the investment of resources. Accordingly, the enterprise looking to achieve optimal investment of resources may seek to invest in the employees who will have the best return on the resource allocation. However, the return on resource investment may vary depending on the whether the expected return in measured in the long term, mid-term or short term.

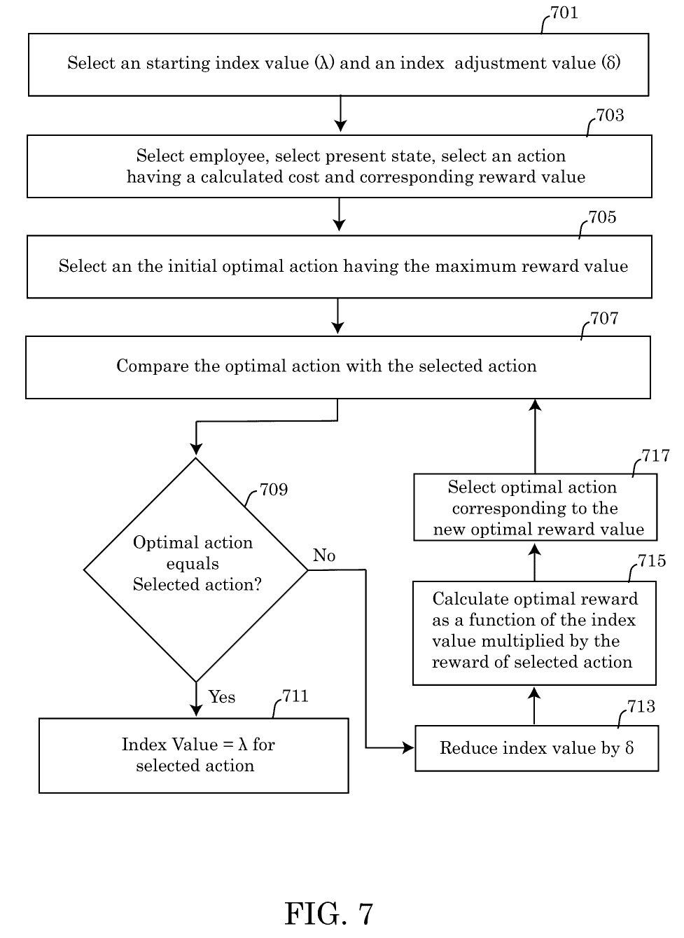

FIG. 7 describes in greater detail an embodiment of a method for calculating the index value for each employee action. In step 701, the resource management tools select the starting parameters for making the index value calculation. The Resource management tools may select a starting index value and an index adjustment value, which may be referred to by the symbol “δ.” In the exemplary embodiment, the starting index value may be a particularly large number in order to ensure that the calculation of the index value is much higher than the actual optimal reward. This allows for the resource management tools to incrementally decrease the index value until the optimal index value is achieved. Optimal Index value represents the minimum value of the shadow price λ for which the given action is optimal. The action is not optimal for any value of the shadow price which is less than the index value.

In step 703, the resource management tools may select an employee of interest from a plurality of the enterprise employees. The resource management tools may also select the state, “s”, an employee action “a”, having an associated cost and a corresponding reward value, “r”, which may be a function of the state and action and defined by the function “r(s,a).” In step 705, the resource management tools may select the optimal action having the maximum reward previously calculated in step 409. Subsequently, in the resource management tools in step 707 of the index calculation method may compare optimal action with the selected action. The resource management tools may make the determination in step 709 of whether the optimal action is the selected action. If in step 709, it is determined that the optimal action at the present state is not equal to the action selected, the resource management tools may proceed to step 713.

In step 713, embodiments of the resource management tools reduce the index value, λ, by the index adjustment value δ, to calculate a new index value for λ, wherein the new λ=λ−δ. In some embodiments, once the reduced index value λ is calculated, the resource management tools may calculate the optimal reward in step 715, described by the function R(s,a). The one period reward R(s,a) is equal to λ*r(s,a), wherein the one period reward is equal to the index value multiplied by the reward value of the selected action. In step 715, embodiments of the resource management tools are calculating the index value that makes the selected employee action optimal. As the index value changes, different actions may be considered the optimal action.

In step 717 of the method prescribed in FIG. 7, the optimal reward value is updated to correspond to the new reward value R(s,a). Based on the reward value, the updated optimal action may be selected by comparing the calculated optimal reward value, R(s,a), with the stored dataset created in step 607 of embodiment 600. Once the optimal reward is calculated, the corresponding optimal action is selected from the dataset. Accordingly, the updated optimal action may once again be compared with the selected action in step 707, and the determination may be made by the resource management tool in step 709. If in the determination step 709, the optimal action still does not equal the selected action, the resource management tools may reduce the index value again in step 713 and proceed to steps 715, 717 and 707. Steps 713, 715, 717, 707 and 709 may be continuously performed by the resource management tools until the determination made in step 709 identifies the selected action as being equal to the optimal action. Accordingly, once the selected action is equal to the optimal action, the index value of λ is selected and recorded in a database as having an index value for the selected employee, for the selected employee action and a corresponding cost paired with the index value. Embodiments of the method steps performed in steps shown in FIG. 7 may be repeated for every employee action presently available for the employee in the present state, “s” and for every employee of the enterprise.

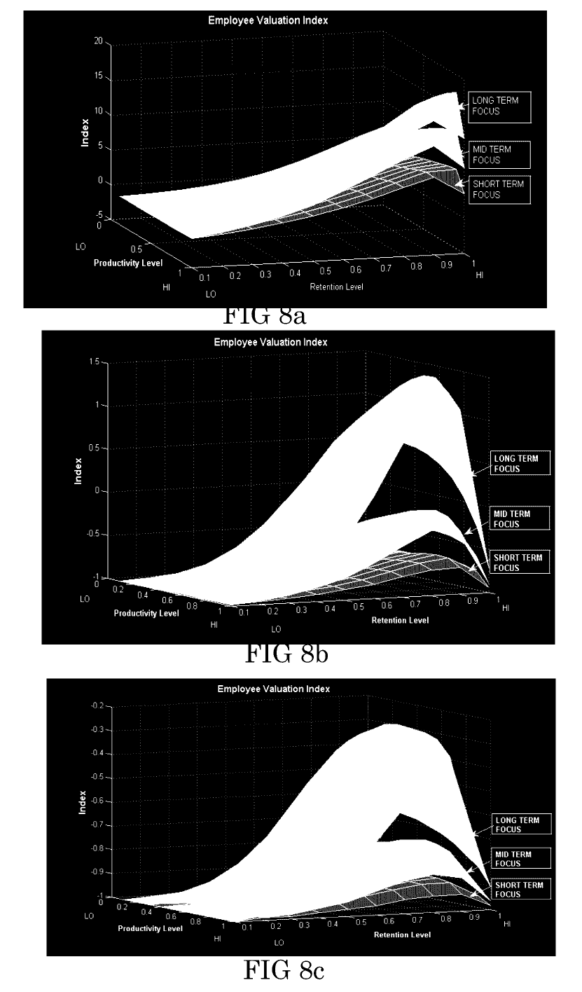

Referring to the drawings, FIG. 8a-8c provides an example of an employee valuation indices, that may be generated from a compilation of index values calculated for each individual employee of the enterprise. Each of the employee valuation indices may provide the local managers of the enterprise with valuable information and visualization tools for investing resources in particular employees, regions and sectors of the economy. As shown in the comparison between the different actions, A1, A2 and A3, it is clear that the index values and the subsequent rewards from an action may depend on the time period of focus for allocating resources by performing the employee action and differences between the actions themselves. For example, action A1 may be considered the most valuable action when compared with actions A2 and A3. As it can be seen, A1 has higher a higher indices value for long term, mid-term and short term focuses. Accordingly, the indices for action A3 shown in FIG. 8c would be considered the least valuable action out of A1, A2, and A3 for long, mid and short term focuses. However, it is not always true that one action may be better than the others over all lengths of time. In some embodiments, a particular action may have the highest benefits over a short or mid-term focus, but not have the optimal rewards for long term, while in other embodiments a different action may reap higher short term rewards but suffer from a lack of mid-term and long term rewards compared with a different action.

For example, an employee action such as increasing compensation may be more valuable in a short term or mid-term focus, but may not be nearly as valuable in a long term focus compared with a different employee action, such as a promotion action which may have a higher index value and reward value for a long term focus goal. When making automated decisions regarding the allocation of enterprise resources using the resources management tools, index values generated for each possible action may be taken into consideration along with the goals of the enterprise to determine optimal rewards based on both the time periods for the employee action as well as the rewards obtained between different actions.

Referring back to the flow chart in FIG. 4, the calculated index values and cost pair for each employee action may be calculated, collected and transmitted by the resource management tools of one or more nodes of the enterprise network 7 to a central node of the enterprise network. Each node transmitting the index values and cost pairs to the central node of the network in step 413 may be an individual resource management system operated by a local or regional manager inputting employee data and calculating index values for each of the local employees As noted above, the enterprise may span the globe, over large distances. Each group of employees may have a different manager responsible for calculating index values for a particular set of employees. In step 413 the index values and costs resulting from the performance of the previously localized steps of 401, 403, 405, 407, 409 and 411 are transmitted by a plurality of nodes performing the steps of the resource management tools.

The central node, receiving the transmission sent in step 413, not only receives the index values and cost pairs from one local or manager, who has calculated the index values of the manager's employees, but the central node also receives index values from every other manager of the enterprise transmitting local employee index values from a plurality of different nodes of the resource management network. The resource management tools loaded in the central node may receive the indices from every manager around the world, and proceed to calculate a single, globalized, index threshold. The index threshold value informs the localized managers whether or not the performance of a particular employee action, as a function of the index values would be the optimal allocation of enterprise resources. The index threshold value identifies to the local managers, that only employee actions having an index value that arises above the threshold are worthy of receiving enterprise resources. However, where an employee has multiple actions available that rise above the index threshold value, the enterprise will select the action with the lowest index value that is greater than the index threshold.

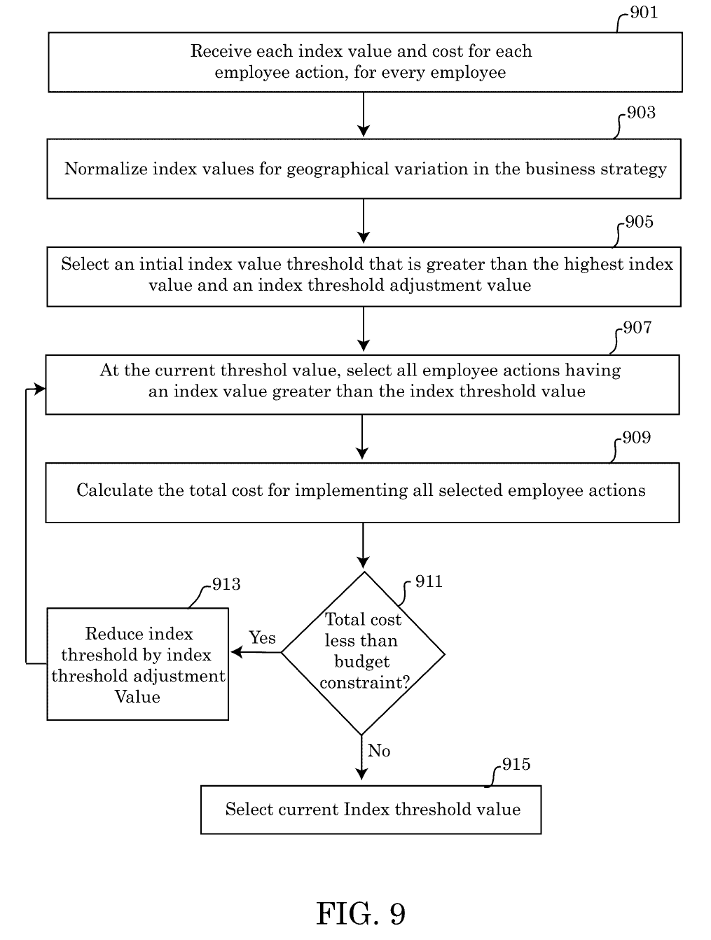

FIG. 9 discloses an embodiment of a method for calculating the index threshold value at the central node. In step 901, the resource management tool of the central node receives each index value and cost pair for every employee action that may be possible to implement, for each employee of the enterprise. In some embodiments, the resource management tools of the central node may further normalize the index values, or balance the index values to account for variances between the different indexes values of different geographic locations in step 903. Moreover, in some embodiments, the index values received from the local managers may be further weighted or normalized based on the current business strategy. For example, index values for particular thriving markets or sectors may be adjusted upward to account for the enterprise's desire to increase the amount of resources expended on employee actions for that particular sector or market.

Likewise, sectors of the enterprise that may not be thriving under the current economic conditions may have the index values weighted in a manner that decreases the values by a particular rate. For example, to weight a particular region's index values, or the index values of a particular sector of the enterprise, in either the positive direction, the index values may be multiplied by a value greater than 1, whereas, conversely, a group of employees who the enterprise may desire to decrease their index values, may have the index values multiplied by a multiplier of less than 1.

In step 905, the resource management tools proceed with the calculation of the index threshold by selecting an initial index threshold value and an index threshold adjustment value. Embodiments of the initial index threshold value may be selected by the resource management tools as a value higher than the maximum index value for any one particular employee, ensuring that the number of employee actions approved in the first round of calculating the index threshold value is always zero. The initial threshold index value selected at step 905 may be represented by the function index threshold (λ**)=max(λ′(a,e)+1, wherein λ′ is the normalized index value of step 903, for the proposed action “a” of the selected employee “e”.

In step 907, the resource management tools calculate, at the current index threshold value, the number of employee actions that have an index value greater than the index threshold value. As stated above, the first round of calculation sets the index threshold value higher than the highest index value. Subsequently in step 909, the resource management tools calculate the total amount of resources consumed thus far based on the actions approved. Approved actions are employee actions that have an index value greater than the threshold.

As stated above, each index value has a cost pair. The resource management tools identify the corresponding cost for each approved action and add each cost pair together to find the total investment cost to the enterprise for implementing each approved action thus far. The investment cost of enterprise resources may be identified by the function I=Sum(e) Cost(A*(e),e), wherein the “I” is the summation of costs for each employee “e”, for every approved action (A*(e),e).

In step 911, the resource management tools make a determination of whether the total investment cost “I”, which includes the enterprise resource investment cost of every approved employee action, is less than the budget constraint for the entire enterprise. If the resource investment cost is less than the available budge (I<budget), the resource management tools proceed to step 913. In step 913, the index threshold value is reduced by the pre-set threshold adjustment value, represented by the formula λ**=λ**−δ, calculating an updated index threshold value.

Embodiments of the resource management tools proceed to re-compare each index value with the updated index value threshold in accordance with step 907. Upon the second or subsequent re-comparison with a lower updated threshold index value, an increased number of employee actions will be approved for resource allocation by the enterprise. By increasing the number of approved employee actions, the total cost calculated in step 909 will also increase. As the total cost of investment rises in conjunction with the adjustment of the index threshold value in step 913, eventually the total cost will no longer be less than the budget constraint in step 909. Accordingly, when the resource management tools have found an index threshold wherein I≧budget constraint, the resource management tools select the present index threshold value that meets the budget constraint, as the index threshold value. The index threshold value is stored in each indices received from each local manager. The central mode transmits each of the indices back to the appropriate node of the local managers. In step 415, the local managers receive the updated indices having the calculated index threshold value.

In step 417, the resource management tools implement each employee action having an index value that is greater than the index threshold value for each employee id. However, some employees may have multiple employee actions that have an index value greater than the index threshold value. Under those circumstances, the resource management tools will implement the employee action having the lowest index value that rises to a level above the index threshold value. In some embodiments one or more employees may not have any employee actions with an index value above the index threshold value. When an index value for each employee action is below the index threshold, no employee action may be taken for the particular employee.

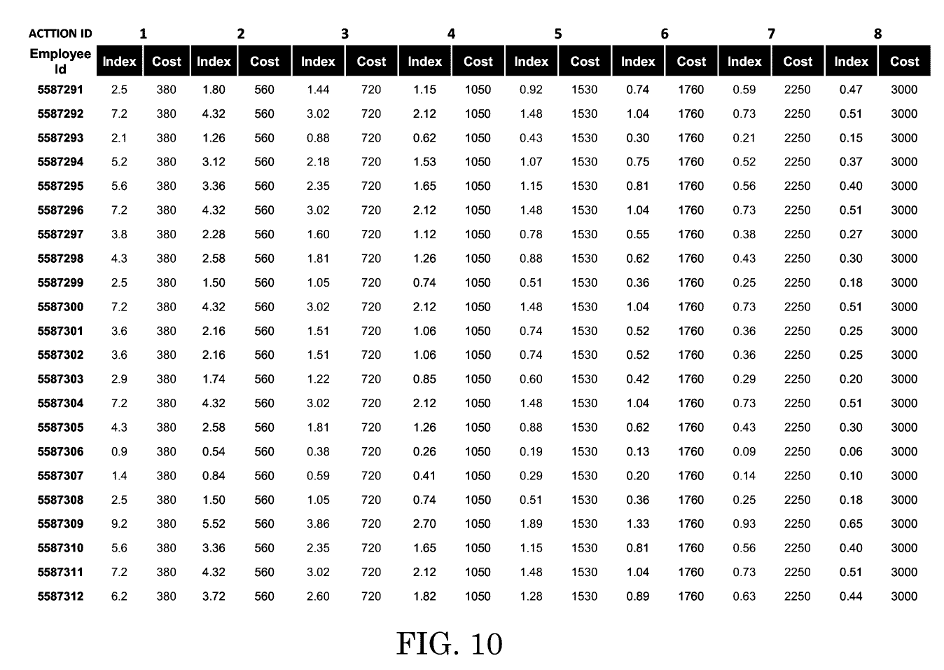

FIG. 10 provides sample indices for calculating the employee actions being implemented by the resource management tools. Using FIG. 10 as an example, with an example threshold of 2.58, it can be seen that the first employee id does not have any actions that qualify for an employee action because all index values are below the index threshold in this example. However, the second employee in the table, employee id 5587292 has two employee actions that rise to a level greater than the threshold value of 2.58. These actions include employee action 1, action 2 and action 3. However, since employee action 3 is the lowest index value that is greater than the threshold value, the resource management tools will approve the implementation of action 3 only for the particular employee id. This comparison is performed for each employee included in the indices, for each manager utilizing the resource management tools.

FIG. 11 illustrates a computer system 1190 used for automating employee management decisions, in accordance with embodiments of the present invention. The computer system 1190 comprises a processor 1191, an input device 1192 coupled to the processor 1191, an output device 1193 coupled to the processor 1191, and memory devices 1194 and 1195 each coupled to the processor 1191. The input device 1192 may be, inter alia, a keyboard, a mouse, etc. The output device 1193 may be, inter alia, a printer, a plotter, a computer screen, a magnetic tape, a removable hard disk, a floppy disk, etc. The memory devices 1194 and 1195 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 1195 includes a computer code 1197 which is a computer program that comprises computer-executable instructions. The computer code 1197 includes software or program instructions that may implement an algorithm for automating employee management decisions. The processor 1191 executes the computer code 1197. The memory device 1194 includes input data 1196. The input data 1196 includes input required by the computer code 1197. The output device 1193 displays output from the computer code 1197. Either or both memory devices 1194 and 1195 (or one or more additional memory devices not shown in FIG. 11) may be used as a computer usable storage medium (or program storage device) having a computer readable program embodied therein and/or having other data stored therein, wherein the computer readable program comprises the computer code 1197. Generally, a computer program product (or, alternatively, an article of manufacture) of the computer system 1190 may comprise said computer usable storage medium (or said program storage device).

Thus the present invention discloses a process for supporting, deploying and/or integrating computer infrastructure, integrating, hosting, maintaining, and deploying computer-readable code into the computer system 1190, wherein the code in combination with the computer system 1190 is capable of performing a method for automating employee management decisions.

While FIG. 11 shows the computer system 1190 as a particular configuration of hardware and software, any configuration of hardware and software, as would be known to a person of ordinary skill in the art, may be utilized for the purposes stated supra in conjunction with the particular computer system 1190 of FIG. 11. For example, the memory devices 1194 and 1195 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for optimizing an allocation of enterprise resources, said method comprising the steps of:
receiving, by the computer processor, a set of employee data from one or more data sources;
identifying, by the computer processor, as a function of the set of employee data, a state of an employee;
generating, by the computer processor, a probability of the employee transitioning from the state of the employee to a different state as a function of a selected employee action having a reward value;
calculating, by the computer processor, as a function of the probability, an optimal employee action wherein the optimal employee action yields an optimal reward;
computing, by the computer processor, an index value and cost pair for the selected action, wherein the index value is reduced until the index value multiplied by the reward value renders the selected employee action as the optimal employee action;
transmitting, by the computer processor, the index value and the cost pair to a central node;
receiving, by the computer processor, an index threshold value from the central node, wherein the index threshold value is calculated as a function of the index value and cost pair transmitted to the central node; and
comparing, by the computer processor, the index value of the selected employee action with the index threshold value.

2. The method of claim 1, wherein the set of employee data includes a dataset of objective attributes selected from the group consisting of employee productivity, efficiency, expertise, and relative wage, and a dataset of subjective feedback selected from the group consisting of a manager feedback value and a peer feedback value.

3. The method of claim 1, wherein the selected employee action is selected from a group consisting of promoting, increasing compensation, up-skilling training and cross-skilling training.

4. The method of claim 1, wherein the index value of the selected employee action is greater than the index threshold value.

5. The method of claim 1, wherein the step of computing the index value and cost pair further comprises the steps of:
selecting, an initial index value and an index adjustment value (6);
comparing, by the computer processor, the selected employee action and the optimal employee action;
further comparing, by the processor, the optimal reward with the reward value multiplied by the initial index value;
reducing, by the computer processor, the initial index value in an increment of the index adjustment value;
updating, by the computer processor, the optimal employee action having an optimal reward equal to the reward value multiplied by the initial index value;
continuously executing, by the computer processor, the comparing, further comparing, reducing and updating steps until the selected employee action is the same as the optimal employee action.

6. The method of claim 1, wherein the index value threshold received by the computing processor is the index value threshold at which a summation of all costs for performing a plurality of employee actions having the index value greater than the index value threshold is equal to a budget constraint value.

7. The method of claim 1, wherein the step of transmitting is performed by the computer processor of a first node on a cloud computing network to the central node of the cloud computing network.

8. The method of claim 1, further comprising providing at least one support service for at least one of creating, integrating, hosting, maintaining, and deploying computer-readable program code in a computer system, where the computer-readable program code in combination with the computer system is configured to implement the steps of receiving, identifying, generating, calculating, computing, transmitting, receiving and comparing.

9. A computer program product, comprising one or more computer readable hardware storage devices having computer readable program code stored therein, said program code containing instructions executable by the one or more computer processors to implement a method for optimizing an allocation of enterprise resources, said method comprising the steps of:
receiving, by the computer processor, a set of employee data from one or more data sources;
identifying, by the computer processor, as a function of the set of employee data, a state of an employee;
generating, by the computer processor, a probability of the employee transitioning from the state of the employee to a different state as a function of a selected employee action having a reward value;
calculating, by the computer processor, as a function of the probability, an optimal employee action wherein the optimal employee action yields an optimal reward;
computing, by the computer processor, an index value and cost pair for the selected action, wherein the index value is reduced until the index value multiplied by the reward value renders the selected employee action as the optimal employee action;
transmitting, by the computer processor, the index value and the cost pair to a central node;
receiving, by the computer processor, an index threshold value from the central node, wherein the index threshold value is calculated as a function of the index value and cost pair transmitted to the central node; and
comparing, by the computer processor, the index value of the selected employee action with the index threshold value.

10. The computer program product of claim 9, wherein the set employee data includes a dataset of objective attributes selected from the group consisting of employee productivity, efficiency, expertise, and relative wage, and a dataset of subjective feedback selected from the group consisting of a manager feedback value and a peer feedback value.

11. The computer program product of claim 9, wherein the selected employee action is selected from a group consisting of promoting, increasing compensation, up-skilling training and cross-skilling training.

12. The method of claim 9, wherein the step of transmitting is performed by the computer processor of a first node on a cloud computing network to the central node of the cloud computing network.

13. The computer program product of claim 9, wherein the step of calculating the index value and cost pair further comprises the steps of:
selecting, an initial index value and an index adjustment value (δ);
comparing, by the computer processor, the selected employee action and the optimal employee action;
further comparing, by the processor, the optimal reward with the reward value multiplied by the initial index value;
reducing, by the computer processor, the initial index value in an increment of the index adjustment value;
updating, by the computer processor, the optimal employee action having an optimal reward equal to the reward value multiplied by the initial index value;

14. The computer program product of claim 9, wherein the index value threshold received by the computing processor is the index value threshold at which a summation of all costs for performing a plurality of employees action having the index value greater than the index threshold value is equal to a budget constraint value.

15. A computer system, comprising one or more processors, one or more memories coupled to the one or more computer processors, and one or more computer readable storage devices coupled to the one or more processors, said one or more storage devices containing program code executable by the one or more processors via one or more memories to implement a method for optimizing an allocation of enterprise resources, said method comprising the steps of:
receiving, by the computer processor, a set of employee data from one or more data sources;
identifying, by the computer processor, as a function of the set of employee data, a state of an employee;
generating, by the computer processor, a probability of the employee transitioning from the state of the employee to a different state as a function of a selected employee action having a reward value;
calculating, by the computer processor, as a function of the probability, an optimal employee action wherein the optimal employee action yields an optimal reward;
computing, by the computer processor, an index value and cost pair for the selected action, wherein the index value is reduced until the index value multiplied by the reward value renders the selected employee action as the optimal employee action;
transmitting, by the computer processor, the index value and the cost pair to a central node;
receiving, by the computer processor, an index threshold value from the central node, wherein the index threshold value is calculated as a function of the index value and cost pair transmitted to the central node; and
comparing, by the computer processor, the index value of the selected employee action with the index threshold value.

16. The computer system of claim 15, wherein the set employee data includes a dataset of objective attributes selected from the group consisting of employee productivity, efficiency, expertise, and relative wage, and a dataset of subjective feedback selected from the group consisting of a manager feedback value and a peer feedback value.

17. The computer system of claim 15, wherein the selected employee action is selected from a group consisting of promoting, increasing compensation, up-skilling training and cross-skilling training.

18. The computer system of claim 15, wherein the step of transmitting is performed by the computer processor of a first node on a cloud computing network to the central node of the cloud computing network.

19. The computer system of claim 15, wherein the step of calculating the index value and cost pair further comprises the steps of:
selecting, an initial index value and an index adjustment value (δ);
comparing, by the computer processor, the selected employee action and the optimal employee action;
further comparing, by the processor, the optimal reward with the reward value multiplied by the initial index value;
reducing, by the computer processor, the initial index value in an increment of the index adjustment value;
updating, by the computer processor, the optimal employee action having an optimal reward equal to the reward value multiplied by the initial index value;
continuously executing, by the computer processor, the comparing, further comparing, reducing and updating steps until the employee action is the same as the optimal employee action.

20. The computer system of claim 15, wherein the index value threshold received by the computing processor is the index value threshold at which a summation of all costs for performing a plurality of employee actions having the index value greater than the index value threshold, is equal to a budget constraint value.
